(19) United States
(12) Patent Application Publication
(10) Pub. No.: US 2005/0238898 A1
(43) Pub. Date: Oct. 27, 2005

(54) Compliant overprint varnishes

(75) Inventors: Donald G. Wind, Gibsonia, PA (US); Jeffrey R. Kubala, Glenshaw, PA (US)

Correspondence Address: IPLM GROUP, P.A., POST OFFICE BOX 18455, MINNEAPOLIS, MN, 55418, US

(73) Assignee: Valspar Sourcing, Inc, Minneapolis, MN (US)

(21) Appl. No.: 10/522,120

(22) PCT Filed: May 2, 2003
(86) PCT No.: PCT/US03/13913

§ 371 Date: Jun. 17, 2005

Related U.S. Application Data
(60) Provisional application No. 60/377,523, filed on May 3, 2002.

(51) Int. Cl. B32B 27/06

(52) U.S. Cl. 428/480

(57) ABSTRACT

A coating composition useful as a varnish coating and coated substrates coated therewith, the composition comprising an alkyd resin having a number average molecular weight of between about 500 and 2,000, and a polydispersity of less than about 2. The coating composition, after being rebaked, is substantially color stable. The coating composition is substantially flexible for use as a can container body varnish.

### RELATED APPLICATION

This application claims the benefit of PCT Application No. PCT/US03/13913 filed May 2, 2003, entitled COMPLIANT OVERPRINT VARNISHES, which in turn claims the benefit of U.S. provisional application Ser. No. 60/377,523, filed May 3, 2002, entitled COMPLIANT OVERPRINT VARNISHES, the disclosures of both of which are herein incorporated by reference.

### BACKGROUND

Varnishes are useful as coatings on wood, plastic, metal, and similar substrates. Varnish products have been used to provide exterior coatings to substrates (such as aerosol spray cans and the like), and/or as decorative coatings. In some applications the varnish may be applied onto a flat sheet substrate that may be later formed into an article of choice. Alternatively, the varnish may be applied over one or more layers of decorative coating or image. In still other applications, the varnish may be applied to a base coating that is typically clear or white.

Some varnish applications are more efficient when applied over a wet substrate. Other applications require the varnish to be applicable to a dry substrate. It is therefore desired that a varnish coating be applicable to both wet and dry substrates.

It is also expected that a varnish coating may be subjected to multiple bake cycles depending on the surface of the substrate it is applied to. Where the varnish is applied to an exterior surface of a substrate, it is common that a subsequent interior coating may be applied, thus requiring another bake cycle. For example, paint can “plugs” are coated both on the inside and outside. It is a long sought desire, to prevent the varnish coating from turning yellow or becoming discolored after being subjected to multiple bake cycles.

As an exterior coating, the coated varnish should also possess good abrasion resistance.

In today's environment, the desire for varnishes and related materials to be more environmentally sensitive is increasing. High levels of volatile organic compound (VOC) content in solutions and coating compositions are not desirable.

From the foregoing, it will be appreciated that what is needed in the art is a low VOC content coating composition that is suitably flexible for the forming process, abrasion resistant for external use, does not yellow or discolor, and can be applied to a dry or wet surface. Such a coating composition and methods for preparing the same are disclosed and claimed herein.

### SUMMARY

In one embodiment, this invention provides a coating composition comprising an alkyd resin having a polydispersity of less than about 2, and a crosslinker. The alkyd resin is preferably a reaction product of a polyester component and a substantially saturated fatty acid component. The fatty acid component is preferably naturally occurring, and is more preferably selected from the group consisting of: palmitic acid, lauric acid, stearic acid, caprylic acid, and myristic acid. The coating composition of the present invention preferably is substantially color stable.

In another embodiment, this invention provides a coated substrate that is coated with the aforementioned coating composition.

In another embodiment, this invention provides an alkyd resin composition comprising a polyester component and a fatty acid component. The alkyd resin composition preferably has a number average molecular weight of between about 500 and 2,000, and a polydispersity of less than about 2. The fatty acid component of the alkyd resin is preferably naturally occurring and is more preferably substantially saturated.

### DETAILED DESCRIPTION

The present invention provides a novel coating composition that is preferably useful as a varnish coating. In one preferred embodiment of the present invention, the coating composition comprises an alkyd resin, a crosslinker, and optionally, a reactive diluent, a solvent, a wax, and/or a flow control agent. Suitably, the coating composition of the present invention is substantially color stable. Preferably, the Ab color component of the coating composition, after being rebaked is no greater than about +1 unit, when evaluated using the Hunter Lab ColorQuest Colorimeter.

The alkyd resin of the coating composition preferably comprises the reaction product of a polyester component and a substantially saturated fatty acid component. Preferably the alkyd resin has a polydispersity of less than about 2.

The polyester component preferably is the reaction product of an acid component and a polyol component. Suitable acid components include aromatic or aliphatic acids (or the anhydrides of these acids). Typical acid components may be mono-functional (such as benzoic acid), di-funcitonal (such as phthalic acid), or tri-functional (such as trimellitic acid), and their anhydrides. Preferred acid components useful for the polyester component of the present invention include di-functional acids and their anhydrides. Non-limiting examples of suitable difunctional acids include ortho-phthalic acid, isophthalic acid, terephthalic acid, succinic acid, adipic acid, anhydrides of these, and the like. A presently preferred difunctional acid is phthalic anhydride.

The use of acids containing unsaturation (such as maleic acid, fumaric acid, itaconic acid, and dimerized fatty acids) is presently believed to be less preferred. Similarly, mono-functional acids (such as benzoic acid), and tri-functional acids (such as trimellitic acid) are also presently considered less preferable.

Suitable polyol components include mono-functional and multi-functional (e.g., di-functional and tri-functional) polyols. Polyol components are believed to affect the compatibility of the polyester component, and thus the compatibility of the alkyd resin to other alkyd resins used in commercially available inks. Polyol components are also believed to affect the flexibility and hardness of the alkyd resin composition. Therefore, a careful selection of the polyol components is preferred. Typical polyols useful in the present invention include, for example, neopentyl glycol, trimethylol propane, 1,4-butanediol, ethylene glycol, 1,4-cyclohexanedimethanol, 1,3-propanediol, 1,6-hexanediol, trimethylolethane, and the like. Presently preferred polyols include neopentyl glygol, trimethylol propane, and combinations thereof.

The acid component and polyol components are preferably present in an amount sufficient to form the desired polyester component. The equivalent ratio of the acid component functionality to the polyol functionality is preferably 1:1.15-1.6 equivalents of the polyol, more preferably 1:1.3-1.55, and most preferably 1:1.4-1.5.

As stated above, the alkyd resin of the present invention preferably comprises a fatty acid component. While not intending to be bound by theory, a careful selection of the fatty acid component is presently believed to substantially diminish or eliminate the likelihood of the coating composition “yellowing” after curing and rebaking. The fatty acid component of the present invention is preferably selected from naturally occurring fatty acids that are substantially saturated.

As used herein, the term “substantially saturated” means that the fatty acid component of the present invention has no more than an average of 0.04 carbon-carbon double bonds per fatty acid component. The term “essentially saturated” means that the fatty acid component has no more than an average of 0.02 carbon-carbon double bonds per fatty acid component. The term “completely saturated” or “saturated” means that the fatty acid component has no more than 0.01 carbon-carbon double bonds per fatty acid component. Preferably, the fatty acid component comprises up to 18, and more preferably between about 6 and 16 carbon atoms, and is saturated. Typical substantially saturated fatty acids that are useful in the present invention include palmitic acid, lauric acid, stearic acid, capric, caprylic acid, myristic acid, arachidic, behenic, lignoceric, and the like.

Unsaturated fatty acids (such as those naturally occurring in castor, tall, linseed, soybean, coconut, palm, and safflower oils) are believed to be less preferred in the preparation of alkyd resin that minimize or eliminate undesirable yellowing of the coating composition. Consequently, these unsaturated fatty acids can be used where yellowing is not a concern, or can be used in moderation where minimal yellowing is acceptable. Unsaturated fatty acids that have been fully hydrogenated can also be used.

The fatty acid component is typically present in an amount suitable to effectively provide compatibility with alkyd-based inks. Suitably, the fatty acid component comprises up to about 40 weight percent of the alkyd resin composition. Preferably, the amount of fatty acid useful in the present invention ranges between about 20 and 40 weight percent, more preferably between about 30 and 40 weight percent, and most preferably between about 31 and 35 weight percent of the alkyd resin composition.

The alkyd resin composition of the present invention preferably has low polydispersity. The low polydispersity of the alkyd resin is believed to provide a low viscosity, low VOC content resin which yields a high degree of flexibility in the coating composition. Preferably, the polydispersity of the alkyd resin is less than about 2, more preferably less than about 1.7, and most preferably less than about 1.5.

The alkyd resin preferably has a number average molecular weight suitable for coating, curing and rebaking. Very low number average molecular weight resins (e.g., resins having molecular weight of less than 500) are believed to be less than optimal, and may, for example, generate a large amount of fumes during the curing and rebake cycle. Typically, the number average molecular weight of the alkyd resin is less than about 2,000. Preferably the number average molecular weight of the alkyd resin ranges between about 500 and 2,000, more preferably between about 700 and 1,500, and most preferably between about 800 and 1,200.

Typically, the viscosity of the alkyd resin is low enough to allow for the smooth application of the coating onto the intended substrate. Suitably, the viscosity of the alkyd resin is less than about 25 cm2/second. Preferably, the viscosity of the alkyd resin is between about 15 and 25 cm2/second, more preferably between about 17 and 23 cm2/second, and most preferably between about 18 and 22 cm2/second.

Preferred alkyd resins have acid numbers of from about 2 to about 20, more preferably from about 2 to 10, and most preferably from about 4 to 6. Acid number is defined as milligrams of potassium hydroxide required to neutralize one gram of polymer solids. Acid number is evaluated according to ASTM D 974-01.

If desired, the alkyd resin of the present invention may be provided as a solution with one or more solvents. Preferred alkyd resin solutions have a solids content of between about 70 and 90 weight percent, more preferably between about 75 and 90 weight percent, and most preferably between about 80 and 90 weight percent. As used herein, solids content refers to the percent by weight of non-volatile component. For example, an alkyd resin with a solids content of 80 percent has 80 percent by weight of non-volatile components and 20 percent by weight of volatile components. Solids content is evaluated according to ASTM D 1259-85

The alkyd resin component of the coating composition is preferably present in an amount sufficient to form a coating composition that is suitable for its intended purpose. For example, a typical coating composition may have at least about 40 weight percent alkyd resin component. Preferably, the alkyd resin component is present in an amount between about 40 and 80 weight percent of the coating composition, more preferably between about 50 and 80 weight percent, and most preferably between about 50 and 70 weight percent.

The coating composition of the present invention preferably includes a crosslinker. The crosslinker is preferably present in an amount sufficient to cause effective crosslinking of the reactants within the desired temperature and time. Typical crosslinkers include amino resins, and blocked polyisocyanates. Suitable crosslinkers include formaldehydes such as melamine formaldehyde, urea formaldehyde, benzoguanamine formaldehyde, glycoluril formaldehyde, and the like. A presently preferable crosslinker is melamine formaldehyde, such as Cymel 1156 available from Cytec Industries of Patterson, N.J.

The amount of crosslinker used in the coating composition of the present invention may affect the hardness, abrasion resistance, and flexibility of the coating composition. Typically, the crosslinker is effective when present in an amount of at least about 10 weight percent of the coating composition. Preferably, the crosslinker is present in an amount between about 10 and 40 weight percent, more preferably between about 15 and 35 weight percent, and most preferably between about 20 and 35 weight percent of the coating composition.

An optional reactive diluent may be included in the coating composition. The reactive diluent may be incorporated in the coating composition to facilitate blending of the components of the coating composition, to improve adhesion of the composition to its intended substrate, and further raise solids content at application without increasing viscosity or VOC content. Suitable reactive diluents include epoxy resins, oligomers, polyether polyols, and other low molecular weight polyfunctional resins. A presently preferred optional reactive diluent is an epoxy resin, such as Diglycidyl ether of Bisphenol A, available as Epon 828 from Resolution Performance Products of Houston, Tex. If desired, the epoxy resin may be modified to make it suitable for intended purposes. The modification process may include enhancement or otherwise increasing the molecular weight of the epoxy resin, such as by the reaction with Bisphenol A, or as is known in the art.

In preferred embodiments, the optional reactive diluent comprises less than 15 weight percent of the coating composition. Preferably, the amount of reactive diluent present in the coating composition is between about 1 and 15 weight percent, more preferably between about 1 and 10 weight percent, and most preferably between about 1 and 5 weight percent of the coating composition.

The coating composition may optionally include a solvent. The optional solvent may function as a carrier for the other components of the coating composition or to facilitate the blending of the ingredients into a composition suitable for coating or processing, etc. Typical optional solvents include aliphatic and aromatic solvents such as mineral spirits, xylene, alcohols, ketones, esters, glycol ethers, and the like. A presently preferable optional solvent includes aromatic distillates combined with glycol ethers and alcohols.

When solvents are used, it is preferable that the amount be less than about 35 weight percent of the coating composition, more preferably less than about 30 weight percent and most preferably less than about 25 weight percent. In general, the less solvent to be removed in the curing process, the more environmentally preferable the composition becomes.

The coating composition may optionally include a wax. The optional wax may be included to provide lubricity to the coating composition and/or abrasion resistance to the finished coated substrate. Typical optional waxes usable include natural and synthetic waxes such as Carnauba Wax, Petrolatum Wax, Polyethylene Wax, Polymeric Wax, Lanocerin Wax, and the like.

In preferred embodiments, the wax comprises less than about 2 weight percent of the coating dry weight Preferably, the amount of wax in the coating composition is between about 0.5 and 1.8 weight percent, more preferably between about 0.7 and 1.4 weight percent, and most preferably between about 0.9 and 1.1 weight percent.

The coating composition may optionally include a flow control agent. Flow control agents may facilitate the process of coating the composition onto a substrate. The optional flow control agents include silicones, fluorocarbons, acrylic resins, and the like. If optional flow control agents are used, the amount present may be in an amount between about 0.1 and 3 weight percent of the coating composition. Preferably, the optional flow control agents are present in an amount between 0.25 and 3 weight percent, more preferably between about 0.4 and 2 weight percent, and most preferably between about 0.5 and 1.5 weight percent of the coating composition.

A catalyst may optionally be included in the coating composition of the present invention. An optional catalyst may be used, for example, to enhance the reaction process between the alkyd resin and the other components such as reactive diluents and crosslinkers. Catalysts that are useful include acid catalysts (such as inorganic and organic catalysts). Non-limiting examples include sulfonic acids such as paratoluene sulfonic acid, dodecylbenzene sulfonic acid, and the like. In preferred embodiments, the coating composition includes between about 1 and 7 weight percent of catalyst, more preferably between about 4 and 6 weight percent.

The coating composition is preferably suitable for application to the intended substrate. The coating composition may be applied to the intended substrate in any method as is known to those skilled in the art. Typical application processes include roll coating, brushing, and spraying. In preferred embodiments, the coating composition of the present invention may be applied onto a substrate that has been primed or coated with a base coat. Base coats may be clear or pigmented as desired. The coating composition may also be applied onto a substrate having one or more layers of ink, decorative coating or paint. Typically, the coating composition of the present invention may be applied to a coating having multiple layers of ink such as in a multi-station printing process (e.g., 4-color press). Preferred coating compositions may be applied onto a “wet” layer or onto a dried substrate (e.g., a cured layer).

The coated substrate with the coating composition of the present invention is preferably substantially color stable. As used in the present invention “substantially color stable” means that a coated substrate does not substantially discolor or become yellow after being “rebaked.” The “rebake” process, as used herein, relates to the procedure that coated substrates are often subjected to, wherein a coated substrate that has been previously cured or “baked,” is further subjected to a subsequent baking process or processes to dry or cure a subsequently coated substrate (e.g., a subsequent coating applied on the other major opposing side of the coated substrate). For example, a package used as an aerosol can, may have an outer decorative surface (coated with a coating composition of the present invention), and an inner surface that is coated with a protective coating to protect the package contents. The inner surface may be coated baked after the outer coating has already been subjected to a curing process. Consequently, the coating of the present invention should preferably be color stable under “rebake” conditions which may be as high as 10 minutes at 205° C.

The rebake process also accelerates the natural aging process that a coating composition typically undergoes. Coatings that are not color stable tend to discolor over time. Rebaking a cured coating at 205° C. for 10 minutes simulates the natural aging process. A measure of the change between the initial color and the final color after rebaking indicate coatings with a potential to be color stable over prolonged periods of time.

Color stability of the coating composition may be measured as a change between the initial color (L, a, b-values) after curing and the final color after rebaking using a Hunter Lab ColorQuest Colorimeter. Particularly, the change in b-values (denoted as “Δb”) indicates the extent of yellowing of the coating as a result of rebaking. The greater the Δb-value, the more yellowing. Preferably, the change in Δb-values between the initial color after curing, and the final color after rebaking is less than about +1 unit, more preferably less than about +0.5 units, and most preferably less than about +0.25 units.

The coating composition of the present invention preferably has a volatile organic compound (VOC) content of less than about 0.35 kilograms per liter of solids, more preferably less than about 0.25 kilograms per liter of solids, most preferably less than about 0.2 kilograms per liter of solids, and optimally less than about 0.1 kilograms per liter of solids.

Preferably the coating composition has a solids content of between about 60 and 80 weight percent of the composition, more preferably between about 65 and 80 weight percent, and most preferably between about 65 and 75 weight percent of the coating composition.

The coating composition of the present invention is preferably sufficiently flexible to allow the coated substrate to be formed into an intended product. The coated substrate of the present invention may be formed into a variety of products, such paint can plugs, aerosol cans, beer and beverage cans, drug packages, and the like. The initial flexibility of the coating composition preferably is at least about 7 or more flexible, more preferably at least about 9 or more flexible when evaluated under the Erichsen Cup Fabrication Test. The flexibility of the coated substrate is most preferably at least about 5 or better, after 2 minutes of dry heat at 200

As mentioned above, the coating composition of the present invention may be applied by a variety of methods including roll coating. Roll coating may efficiently include application of the coating composition onto a wet substrate (e.g., a substrate that has an applied layer of an unbaked ink or decorative image). Typically, roll coating is used to coat a flat substrate that is subsequently formed into a desired container. For contoured substrates, the coating composition may be applied by processes such as spraying or brushing on.

In preferred embodiments, the coating composition of the present invention provides abrasion resistance to the coated substrate. A substrate with excellent abrasion resistance is preferred to meet the demands of uses, such as in aerosol cans, shaving cream cans, paint cans, and the like.

The constructions cited were evaluated by tests as follows:

### Abrasion Test

An abrasion test is used to simulate a typical abrasion the coated substrate may be exposed to during transportation, such as in a truck. This test was done using a Gavarti Cat Abrasion Tester to measure the abrasion of a coating to another coating. For this test, two 10 cm×10 cm coated sample are placed face-to-face, and sandwiched between abrader pads. Pressure is then applied to the top and sides of the test samples for a pre-determined time. The samples are then rated for coating abrasions. The rating scales used are from 1 to 10, where “1” indicates complete failure and “10” indicates no failure.

### Gloss

Gloss measures the surface luster or smoothness of the coating. The smoother the coating, the higher the gloss value at a particular angle of incident light. The gloss values of the coated samples were measured at 20 and 60 degree angles using a Gardner Glossmeter, model number 4520.

### Color

The color of the coated substrate was measured using Hunter Lab ColorQuest calorimeter. The colorimeter measures the color of a sample (e.g., coated substrate) in standardized values of L for Whiteness/Darkness; “a” for the red/green spectrum; and “b” for the yellow/blue spectrum. The change between each value is coded “Δ” or “delta.” For example, a “Δb” value indicates the change between the initial and final “b” values. A smaller Δb value indicates less yellowing coating after rebaking. Likewise, a positive ΔL value indicates that the substrate looks whiter after rebaking.

### Flexibility

The flexibility of the coated substrate was evaluated using the Erichsen Cup Fabrication Test. The coated substrate was placed in an Erichsen machine, model number 204, and formed into a cup. The formed cup was then placed in a beader to form a 50 bead. The coated substrate was then evaluated to determine the amount of coating that adhered to the bead. The coated substrate was evaluated for flexibility at different locations on the container, for example wall and dome. The flexibilities of the wall and dome locations were also evaluated after subjecting the samples to dry heat at 200° C. for 2 minutes. The test sample was then rated a second time for coating adhesion to the 50 bead.

### Block Resistance

Block resistance measures the resistance of the coated substrate to sticking together in a warm environment, and is aimed to simulate typical coating factory conditions during the hot summer months. The block resistance test is done on the coated substrate before forming into a container. A 5 cm×10 cm sample is coated with an exterior coating on one side and an interior coating on the opposite side, and cured. The coated sample is then stacked with the interior side facing the exterior side, under pressure of 7.03 kgf/cm2 in a blocking jig, for 16 hours at 49° C. The coating resistance is then rated by manually pulling the test samples apart. The samples were rated relative to a known good control and negative control. The rating scale used is from 0 to 10, where “0” is a completely blocked and “10” is no blocking. A rating of better than 7 is acceptable.

### Adhesion

Adhesion testing was performed to assess whether the coating adheres to the coated substrate. The adhesion test was performed according to ASTM D 3359—Test Method B, using a Scotch™ 610 tape, available from Minnesota Mining and Manufacturing (3M) Company of Saint Paul, Minn. For the Adhesion test, a rating of “10” indicates no failure due to adhesion, a rating of “9” would indicate that 90 percent of the coating remained adhered, and a rating of “8” would indicate that 80 percent of the coating remained adhered, etc.

### Wet Inking

Wet inking measures the ability of the varnish to be applied over a wet ink. Wet inking is evaluated by applying an ink over an organic base coat at the desired film weight. A varnish coating was then applied over the wet ink and cured. The ability of the varnish to form a continuous film over the ink is measured. The varnish is then rated by visually inspecting the appearance over the ink for gloss, film continuity, and lack of color fade.

### Blush Resistance

Blush resistance measures the ability of a coating to resist attack by various solutions. Typically, it is measured by the amount of water absorbed into a coating. When the coated substrate absorbs water, it is generally cloudy or looks white. Blush is measured visually on a graduated scale.

### Rating Scale

Rating scale used: 0 to 10, where “0” is a complete failure and “10” is no failure. For the Blush test, a rating of “10” would indicate no whitening of the coated film, a “0” would indicate a complete whitening of the coated film, etc.

### Sterilization or Pasteurization

The sterilization or pasteurization test determines how a coating withstands the processing conditions for different types of products packaged in the container. Typically, a coated substrate is immersed in a water bath and heated to between 65 and 100° C. for about 5 to 60 minutes. For the present evaluation, the coated substrate was immersed in a water bath and heated for 5 minutes at 66° C. The coated substrate was then removed from the water bath and tested for coating adhesion and/or blush.

### Process or Retort Resistance

This is measure of the decomposition of the coated substrate using heat and pressure. The procedure is similar to Sterilization or Pasteurization test (above) except that the testing is accomplished by subjecting the container to heat of between about 105 and 130° C.; pressure of between about 0.7 to 1.05 kgf/cm2; and for about 15 to 90 minutes. In this evaluation, the coated substrate was subjected to heat of 121° C.; pressure of 1.05 kg/cm2; and for 90 minutes. The coating is then tested for adhesion and/or blush.

### SD-40 Resistance

This test measures the coatings ability to withstand exposure to solvents such as hair spray. The test is carried out by exposing a cured test sample to hair spray containing SD-40. The hair spray is allowed to stand 1 minute on the test piece prior to exposure of 5 minutes at 65.6° C. hot water immersion. SD-40 resistance is rated for degree of blush and loss of adhesion immediately following hot water exposure.

### Reverse Impact

The reverse impact test measures the ability of a coating to withstand the deformation encountered when impacted by a steel punch with a hemispherical head without cracking or adhesion loss. The test sample that is coated with basecoat and varnish is subjected to 0.46 kilogram-metres (40 inch-pounds) of force, and rated for cracking and adhesion loss according to ASTM D 2794-93.

### Coefficient of Friction (COF)

The Coefficient of Friction is a measure (number) that describes the surface lubricity. The COF was measured using a tester ALTEK Model Number 9505E. The lower the number, the more slip characteristics the film possesses.

The following examples are offered to aid in understanding of the present invention and are not to be construed as limiting the scope thereof. Unless otherwise indicated, all parts and percentages are by weight.

### EXAMPLES

### Example 1

TABLE 1
Preparation of Alkyd Resin

| Material | Parts by Weight. |
|---|---|
| Palmitic Acid 95% | 27.4 |
| Neopentyl Glycol | 14.9 |
| Trimethylol Propane | 16.6 |
| Phthalic Anhydride | 25.9 |
| Aromatic Distillate 100 | 15.2 |

Palmitic acid 95%, obtainable from Acme-Hardesly and Neopentyl glycol obtainable from Eastman Chemical were charged into a suitable distillation kettle equipped with a Nitrogen blanket. The kettle was heated to between 100 and 110° C. with agitation. While maintaining the temperature at between 100 and 110° C., Trimethylol propane, obtainable from Celanese Chemical and Phthalic anhydride, obtainable from Koppers Chemical were added. The heating was increased to raise the composition temperature to 220° C. and a reflux maintained until an acid number of between 4 and 6 is obtained. Aromatic distillate 100 is added and the batch cooled.

The resulting alkyd resin had solids content of 83.5%, an acid number of 5, and a viscosity of Y-Z1 using a Gardner Bubble Tube.

### Example 2

TABLE 2
Preparation of Coating Composition

| Material | Parts by Weight |
|---|---|
| Alkyd Resin (Ex. # 1) | 49.1 |
| Xylene | 7.2 |
| Eastman EP | 3.6 |
| Wax | 3.6 |
| Cymel 1156 | 24.9 |
| Epon 828 | 7.3 |
| Dowanol PM | 1.5 |
| Eastman EB | 2.1 |
| Nacure 155 | 0.7 |

The alkyd resin from Example 1 above, Xylene and Eastman EP (obtainable from Eastman Chemical) were charged to a clean mixer with moderate agitation. Wax (a combination of Carnauba Wax, Polymeric Wax, and Lanocerin Wax) was added and stirred for 10 minutes. Cymel 1156 (obtainable from Cytec Industries) and Epon 828 (obtainable from Resolution Performance Products, Houston, Tex.) were added under moderate agitation. After 20 minutes, a premix of Dowanol PM (obtainable from Dow Chemical), Ethylene glycol monobutyl ether (Eastman EB, obtainable from Eastman Chemical), and Nacure 155 (obtainable from King Industries) were charged into the mixer. The coating composition was then filtered through a 10-micron bag.

The coating composition obtained had a solids content of 67.3%, a viscosity of 55 seconds using a Ford Cup Viscometer at 26.7° C., and a VOC content of 0.26 kilogram per liter of solids. The coating composition was sampled and tested for volatile organic compound content as described in ASTM 2369-86.

### Example 3

TABLE 3
Preparation of the Comparative Coating Composition

| Material | Parts by Weight |
|---|---|
| Polyester | 26.9 |
| Polyester | 30.8 |
| Melamine Formaldehyde | 16.2 |
| Epoxidized Oil | 3.7 |
| Diethylene Glycol Butyl Ether | 2.3 |
| Acid Catalyst | 2.3 |
| 3-Ethoxyethylpropionate | 16.1 |
| Silicone | 0.7 |
| Wax | 1.1 |

Polyesters (Chempol 010-1782, obtainable from CCP Industries, and EPS 3083, obtainable from Engineered Polymer Solutions) and Melamine Formaldehyde (Cymel 303LF, obtainable from Cytec Industries) were charged to a suitable mixer. Agitation was started to achieve a vortex. Epoxidzed oil (Epoxol 9-5, obtainable from American Chemical) was added under agitation. Diehtylene Glycol Butyl Ether (Eastman DB, obtainable from Eastman Chemical), Acid Catalyst (Nacure 5925, obtainable from King Industries), and 3-Ethoxyethylpropionate (Ektapro EEP, obtainable from Eastman Chemical) were added under agitation. After 10 minutes of agitation, Silicone (Byk 361 and Byk 325, obtainable from Byk-Chemie), and Polymeric Wax (Slip-Ayd SL-404, obtainable from Daniel Products) were then added to the composition with continuous agitation for another 20 minutes. The coating composition was filtered using a JM4 filter cartridge.

The coating composition had a solids content of 68.0%, viscosity of 55 seconds using a Ford Cup Viscometer at 26.6° C., and VOC content of 0.3 kilograms per liter of solids. The coating composition was sampled and tested for volatile organic compound content as described in ASTM 2369-86.

### Example 4

### Preparation of a Comparative Coated Substrate

A 10 cm×20 cm×0.028 cm (4 in×8 in×11 mils) tinplated steel substrate coated with a clear base coat and cured at 193° C. for 10 minutes was coated with the coating composition of Example 3 by bar coating to a coating thickness of 0.0005 cm (0.2 mils). The coated substrate was cured at 171° C. for 10 minutes. The coated substrate was cut in two halves, and one half was then rebaked at 205° C. for 10 minutes for color testing.

### Example 5

### Preparation of a Coated Substrate

A 10 cm×20 cm×0.028 cm (4 in×8 in×11 mils) tinplated steel substrate coated with a clear base coat and cured at 193° C. for 10 minutes was coated with the coating composition of Example 2 by bar coating to a coating thickness of 0.013 cm (5 mils). The coated substrate was cured at 171° C. for 10 minutes. The coated substrate was cut in two halves, and one half was then rebaked at 205° C. for 10 minutes for color testing.

### Example 6

TABLE 6a
Adhesion/Blush Test Results

| | Adhesion | | Blush | |
|---|---|---|---|---|
| | Ex. 4 | Ex. 5 | Ex. 4 | Ex. 5 |
| Process Resistance | 0 | 10 | 0 | 10 |
| Pasteurization | 10 | 10 | 10 | 10 |
| SD-40 Resistance - 5′ @65.6° C. | 10 | 10 | 10 | 10 |
| Impact - 0.46 kg-m (40 in-lbs) | | | | |
| Reverse | 10 | 10 | | |
| Direct | 10 | 10 | | |
| Post Pasteurization Impact - | | | | |
| 0.46 kg-m (40 in-lbs) | | | | |
| Reverse | 10 | 10 | | |
| Direct | 10 | 10 | | |
| Wet Inking - Thermal | | | Gloss 20°/60° | |
| Sun Black | 10 | 10 | 81.1/92.6 | 78.5/93.1 |
| INX Black | 10 | 10 | 83.6/92.3 | 73.9/92.9 |
| INX Pink | 10 | 10 | 80.0/91.2 | 72/92.7 |
| TOBA Black | 10 | 10 | 84.0/92.7 | 83.6/92.6 |

TABLE 6b
Color Test Results
Color

| | Example 4 | | Example 5 | |
|---|---|---|---|---|
| | | After 10′ @ | | After 10′ @ |
| | Before Baking | 205° C. | Before Baking | 205° C. |
| L | 90.65 | 90.9 | 90.1 | 90.2 |
| a | −2.1 | −2.28 | −2.03 | −2.14 |
| b | −1.92 | −0.8 | −2.7 | −2.1 |

TABLE 6c
Flexibillty/Blocking/Coefficient of Friction Test Results
Flexibility/Blocking/COF

| | Example 4 | Example 5 |
|---|---|---|
| Flexibility | | |
| Wall/Dome | 6/10 | 7/10 |
| 50 Bead | 7 | 6 |
| 2′ @149° C. Dry Heat (Wall/Dome) | 2/4 | 2/4 |
| Blocking | 9 | 9 |
| Coefficient of Friction | 0.07 | 0.07 |

TABLE 6d
Abrasion Test Results
Gavarti CAT Abrasion Test

| | Example 4 | Example 5 |
|---|---|---|
| Sun Black | 8 | 8 |
| INX Black | 9 | 7 |
| INX Pink | 7 | 8 |
| TOBA Black | 6 | 8 |

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

1. A coating composition, comprising:
an alkyd resin having a polydispersity of less than about 2, and being the reaction product of a polyester component and a substantially saturated fatty acid component; and a crosslinker, wherein the coating composition is substantially color stable.

2. The coating composition of claim 1, wherein the Δb color component of the coating composition after being rebaked is no greater than about +1 compared to the coating composition after cure but prior to rebake when evaluated using the Hunter Lab ColorQuest Colorimeter.

3. The coating composition of claim 1, wherein the Δb color component of the coating composition after being rebaked is no greater than about +0.5 compared to the coating composition after cure but prior to rebake when evaluated using the Hunter Lab ColorQuest Colorimeter.

4. The coating composition of claim 1, wherein the Δb color component of the coating composition after being rebaked is no greater than about +0.25 compared to the coating composition after cure but prior to rebake when evaluated using the Hunter Lab ColorQuest Colorimeter.

5. The coating composition of claim 1, wherein the coating composition has a volatile organic compound content of less than about 0.35 kilograms per liter of solids.

6. The coating composition of claim 1, wherein the coating composition has a volatile organic compound content of less than about 0.25 kilograms per liter of solids.

7. The coating composition of claim 1, wherein the alkyd resin comprises between about 40 and 80 weight percent of the coating composition.

8. The coating composition of claim 1, wherein the alkyd resin comprises between about 50 and 70 weight percent of the coating composition.

9. The coating composition of claim 1, wherein the alkyd resin has a number average molecular weight of between about 500 and 2,000.

10. The coating composition of claim 1, wherein the percent solids content of the coating composition is between about 60 and 80 weight percent.

11. The coating composition of claim 1, wherein the polyester component is a reaction product of a difunctional acid and a polyol.

12. The coating composition of claim 11, wherein the difunctional acid is selected from the group consisting of: phthalic anhydride, isophthalic acid, terephthalic acid, succinic acid, adipic acid, and mixtures thereof.

13. The coating composition of claim 11, wherein the difunctional acid is phthalic anhydride.

14. The coating composition of claim 11, wherein the polyol is selected from the group consisting of: neopentyl glycol, trimethylol propane, 1,4-butanediol, ethylene glycol, 1,4-cyclohexanedimethanol, 1,3-propanediol, 1,6-hexanediol, trimethylolethane, and mixtures thereof.

15. The coating composition of claim 11, wherein the polyol comprises a blend of neopentyl glycol and trimethylol propane.

16. The coating composition of claim 1, wherein the fatty acid component is naturally occurring.

17. The coating composition of claim 1, wherein the fatty acid component is selected from the group consisting of: palmitic acid, lauric acid, stearic acid, capric acid, caprylic acid, myristic acid, and mixtures thereof.

18. The coating composition of claim 16, wherein the naturally occurring fatty acid comprises between 6 and 16 carbon atoms, and is saturated.

19. The coating composition of claim 1, wherein the alkyd resin has an acid number between about 2 and 10.

20. The coating composition of claim 1, wherein the alkyd resin has an acid number between about 4 and 6.

21. The coating composition of claim 1, wherein the coating composition comprises between about 10 and 40 weight percent crosslinker.

22. The coating composition of claim 1, wherein the crosslinker is selected from the group consisting of: melamine formaldehyde, urea formaldehyde, benzoguanamine formaldehyde, and glycoluril formaldehyde.

23. The coating composition of claim 1, wherein the crosslinker comprises melamine formaldehyde.

24. The coating composition of claim 1, further comprising a reactive diluent, wherein the reactive diluent comprises an epoxy material.

25. The coating composition of claim 1, further comprising a solvent selected from the group consisting of: mineral spirits, xylene, alcohols, ketones, esters, and glycol ethers.

26. The coating composition of claim 1, further comprising a wax selected from the group consisting of: carnauba, petrolatum, and polyethylene.

27. The coating composition of claim 1, further comprising a flow control agent selected from the group consisting of: silicone, fluorocarbons, and acrylic resins.

28. The coating composition of claim 1, further comprising a catalyst selected from the group consisting of: paratoluene sulfonic acid, and dodecylbenzene sulfonic acid.

29. The coating composition of claim 1, wherein the coating composition has an initial flexibility of at least about 7 when tested under the Erichsen Cup Fabrication Test.

30. The coating composition of claim 1, wherein the flexibility of the coating composition is at least about 5 after 2 minutes of dry heat at 200° C. using the Erichsen Cup Fabrication Test.

31. An alkyd resin composition, comprising:
a polyester component comprising a reaction product of a difunctional acid and a polyol; and
a fatty acid component having a polydispersity of less than about 2, wherein the fatty acid component is substantially saturated and naturally occurring, and wherein the alkyd resin has a number average molecular weight between about 500 and 2,000.

32. The alkyd resin of claim 31, wherein the difunctional acid is selected from the group consisting of: phthalic anhydride, isophthalic acid, terephthalic acid, succinic acid, adipic acid, and mixtures thereof.

33. The alkyd resin of claim 31, wherein the difunctional acid is phthalic anhydride.

34. The alkyd resin of claim 31, wherein the polyol is selected from the group consisting of: neopentyl glycol, trimethylol propane, 1,4-butanediol, ethylene glycol, 1,4-cyclohexanedimethanol, 1,3-propanediol, 1,6-hexanediol, trimethylolethane, and combinations thereof.

35. The alkyd resin of claim 31, wherein the polyol comprises a blend of neopentyl glycol and trimethylol propane.

36. The alkyd resin of claim 31, wherein the naturally occurring fatty acid is selected from the group consisting of: palmitic acid, lauric acid, stearic acid, capric acid, caprylic acid, and myristic acid.

37. The alkyd resin of claim 31, wherein the naturally occurring fatty acid comprises between 6 and 16 carbon atoms, and contains no unsaturation.

38. The alkyd resin of claim 31, wherein the acid number of the resin is between about 4 and 6.

39. The alkyd resin of claim 31, wherein the viscosity of the resin is between about 15 cm²/sec and 25 cm²/sec.

40. The alkyd resin of claim 31, wherein the solids content of the resin is between about 70 and 90 percent.

41. A coated substrate, comprising:
a metal substrate coated with a coating composition comprising an alkyd resin, the alkyd resin being a reaction product of a polyester component and a substantially saturated fatty acid component, wherein the fatty acid component is naturally occurring, and wherein the alkyd resin has a number average molecular weight between about 500 and 2,000, and a polydispersity of less than about 2; and a crosslinker, wherein the coating composition is substantially color stable.
